(19) United States
(12) Patent Application Publication
(10) Pub. No.: US 2023/0369870 A1
(43) Pub. Date: Nov. 16, 2023

(54) SYSTEMS AND METHODS FOR BALANCING BATTERIES

(71) Applicants: Ratnesh Kumar Sharma, Fremont, CA (US); Surinder Singh, Fremont, CA (US)

(72) Inventors: Ratnesh Kumar Sharma, Fremont, CA (US); Surinder Singh, Fremont, CA (US)

(21) Appl. No.: 17/741,720

(22) Filed: May 11, 2022

(51) Int. Cl. H02J 7/00

(52) U.S. Cl. CPC H02J 7/0019; H02J 7/007182

(57) ABSTRACT

A method provides power from battery units by placing units with a predetermined variance in voltages in a first configuration; detecting a divergence in module voltages; if the divergence crosses a threshold, creating a new configuration of units to provide an even voltage distribution; and electrically rerouting the units to form the new configuration while the battery units are in an idle state or in a reduced mode of operation.

### BACKGROUND

The present invention relates to rechargeable battery systems.

A system that stores energy and uses it efficiently is becoming important due to environmental destruction and exhaustion of natural resources. Also, new renewable energy is becoming more popular, and rechargeable battery systems have become popular in electric cars as well as smart homes.

In theory, the use of rechargeable battery such as Lithium-ion battery doesn't cause any pollution, or produces very little, during the generation process. A system that interconnects renewable energies, called an energy storage system, could be described as a rechargeable system. This energy storage system could include many different types of Battery Cells, modules or packs, so it is vital to monitor their states such as indirectly measured state of charge and state of health or directly measured variables such as voltage, temperature, current, and so on, to effectively manage them based on monitoring results.

Battery cell balancing is a well-known problem in used and new batteries. For used batteries, however, this problem is aggravated by accumulation of gases (or other non-reagent products) at the interface between electrode and electrolyte and uneven depletion of reagents leading to concentration gradients in the electrolyte-electrode interface thus impeding the flow of ions. Such effects also lead to generation of heat and further affecting the performance of the batteries. Eventually the cell potential reduces, reaction slows and stops prematurely. Additionally, these effects vary from cell to cell and manifests in a spread in the available cell capacity and voltages. This leads to imbalance in cell voltages.

Currently there are two broad methods for balancing cells. Passive method involves draining the high voltage batteries through resistors to match the lower voltage cells. Active method involves sharing the excess charge from higher voltage cells with lower voltage cells. Both involve use of microcontroller and sophisticated power electronic switching circuits. Nevertheless, these methods are very time consuming and case loss in efficiency. Additionally, since the balancing occurs in smaller groups, solution is not scalable to large megapacks.

### SUMMARY

A method provides power from battery units by placing units with a predetermined (or unknown) variance in voltages in a first configuration; detecting a divergence in module voltages; if the divergence crosses a threshold, creating a new configuration of units to provide an even voltage distribution; and electrically rerouting the units to form the new configuration while the battery units are in an idle state or in a reduced mode of operation.

Implementations of the above method may include one or more of the following. The method includes placing cells in a series or a parallel configuration. While the description is mentions battery units, the units can be battery modules, and the approach can be upscaled to battery packs or down scaled to battery cells.

Single pole double throw (SPDT) switches can be used to reconfigure the battery units. The units are taken off-line (electrically/electronically—without manual disassembly) during reconfigurations. The units can be coupled using resistors. The method includes trickle charging a battery cell with the one or more resistors. The method also manages heat dissipation of the one or more resistors. The units can also be connected by capacitors. The method includes balancing voltage differences across the capacitors. In one implementation, the current flow in a branch circuit is as follows:

$${i}_{k} = {C}_{k} \frac{{dv}_{k}}{dt}$$

where iₖ, Cₖ and vₖ are the current, capacitance and voltage of the k^{th} branch. In another embodiment an inductor can be added in series to capacitor to reduce the inrush current. The method includes generating current flow in a branch circuit with resistors or capacitors. An inductive load can be placed in series with the resistors or capacitors. The voltage drop across the inductor is as follows:

$${v}_{l , k} = - {L}_{k} \frac{{di}_{k}}{dt} = - {L}_{k} {C}_{k} \frac{{d}^{2} {v}_{C , k}}{{dt}^{2}}$$

where v_{l,k}, Lₖ and iₖ are the voltage drop across the inductor, inductance of inductor and current in k^{th} branch circuit. The method includes generating current flow in a branch circuit with resistors and capacitors. The method includes providing inductive load in series with resistors or capacitors. The method also includes performing fast switching of SPDT switches to reduce cell balancing current by altering a rate of change of current and increasing voltage drop at an inductor and a capacitor.

Advantages of the method may include one or more of the following. In contrast to the balancing of individual cells in groups using passive or active methods, the present system applies a dynamic configuration of packs to balance energy storage systems at the pack level. The solution involves a hardware and software approach to parallel units with high variance in voltages and obtain an even voltage distribution. As module voltages diverge and the variance crosses a threshold, strings of units are paralleled to create a new configuration. Such a configuration can be done while the ESS is in idle state or in a reduced mode of operation.

### BRIEF DESCRIPTION OF THE DRAWINGS

FIG. 1 shows an embodiment with a resistive circuit.

FIG. 2 shows another embodiment where the resistors are replaced with capacitors.

FIG. 3 shows an exemplary hybrid circuit with resistive and capacitive circuit.

FIG. 4 shows an exemplary remote-control circuit while FIG. 5 shows an exemplary control flow diagram.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art may be omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

One or more embodiments of the present invention include cell balancing methods, cell balancing devices, and energy storage systems including the cell balancing devices that are capable of performing cell balancing efficiently. While cells are mentioned, the system works with battery modules or battery packs as well.

For purpose of this disclosure, an energy storage system (ESS) is composed of packs and packs composed of modules and modules composed of cells. Cells or modules or packs can be placed in series or parallel configuration.

The embodiments of the present invention will be described below in more detail with reference to the accompanying drawings. Those components that are the same or are in correspondence are denoted by the same reference numeral regardless of the figure number, and redundant explanations are omitted.

While the description mentions modules, the approach can be upscaled to packs or down scaled to cells. In design, each module consists of main module and an auxiliary module. The aux module can be placed in parallel to increase the capacity of the ESS or taken offline to act as a balancer. Any excess charge responsible for imbalance can be drained into the aux module.

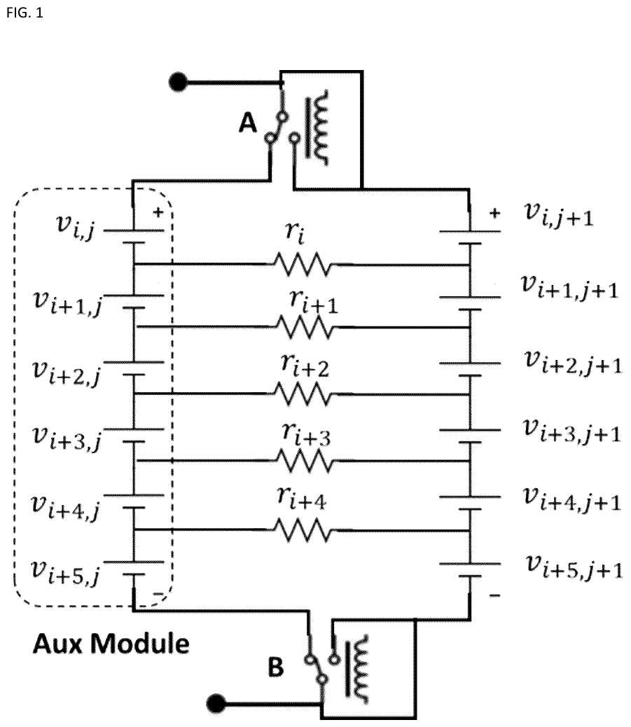

FIG. 1 shows a typical configuration with main module comprising of six cells and a similar auxiliary module comprising of six other cells. SPDT switches A and B are responsible for reconfiguring the modules. Modules can be paralleled or taken off-line. In yet other topologies they could be made to be in series. Typically, cells get imbalanced in series, paralleling restores the balance. Paralleling can lead to high current, heat generation and related safety and degradation issues. High inrush current can lead to cell degradation.

Several approaches of wiring the aux modules to the main modules are proposed. In first case packs can be connected using nkΩ resistors while in the second case nmF capacitors can be used. In case of the resistor approach, when modules are paralleled, the current flows through the resistor trickle charging the lower voltage cell until the cell is balanced. Heat dissipated in the resistor should be managed with heat sinks to avoid thermal management-related failure issues. Such an arrangement can also work when the aux module is off-line. However, resistors need to be disconnected or eliminated once the modules are placed in series.

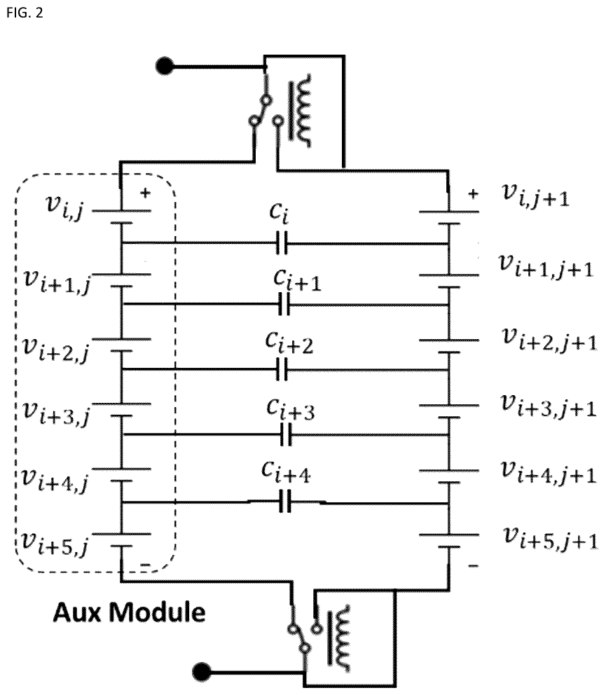

FIG. 2 shows a similar circuit with resistors replaced with capacitors. Voltage difference across the capacitor drives the current until the voltage is balanced. This mechanism leads to fast and regenerative balancing. No heat is generated like that for resistors. Equation defines the current flow in the branch circuits due to imbalanced cells

$${i}_{k} = {C}_{k} \frac{{dv}_{k}}{dt}$$

where iₖ, Cₖ and vₖ are the current, capacitance and voltage of the k^{th} branch.

In another embodiment an inductor can be added in series to capacitor to reduce the inrush current. This will slow the rise of voltage in the capacitor and reduce the balancing current, thus protecting the cells. The voltage drop across the inductor is given by

$${v}_{l , k} = - {L}_{k} \frac{{di}_{k}}{dt} = - {L}_{k} {C}_{k} \frac{{d}^{2} {v}_{C , k}}{{dt}^{2}}$$

where v_{l,k}, Lₖ and iₖ are the voltage drop across the inductor, inductance of inductor and current in k^{th} branch circuit. The voltage drop at the inductor will be highest when the connection between modules are changed. As the voltages across cells get balanced and the current drops, the voltage drop across the inductor will drop to zero.

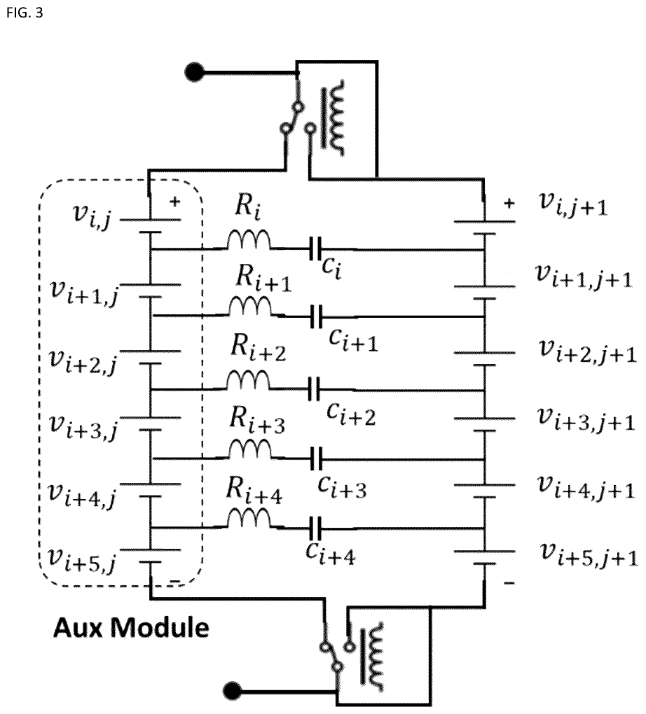

FIG. 3 shows the schematic of the hybrid circuit. Fast switching of the SPDT switch A and B can also reduce cell balancing current by altering the rate of change of current and thus increasing voltage drop at the inductor and the capacitor. While we have explored cell balancing options for a simple combination of cells, this approach can be extended to packs.

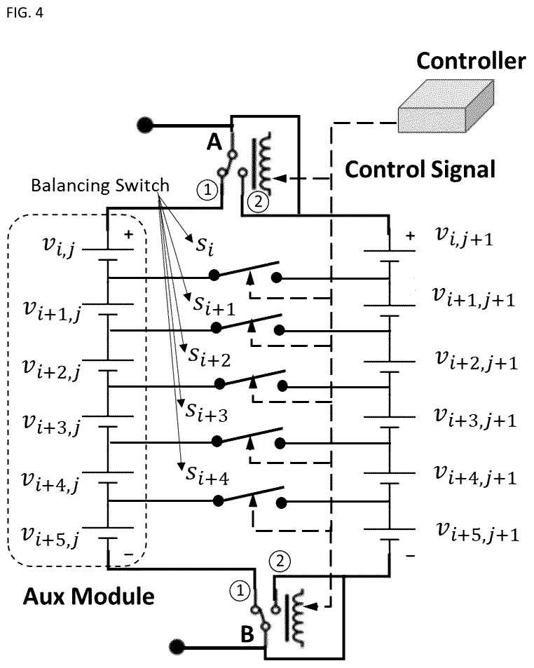

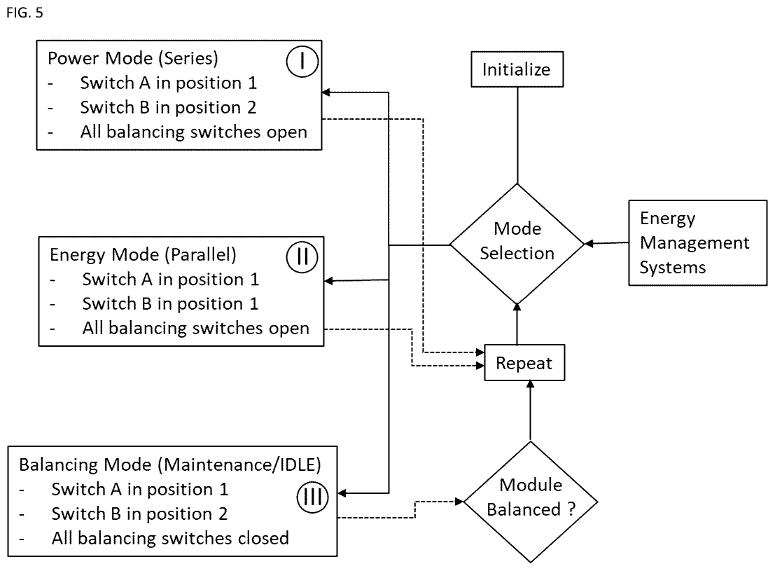

In another embodiment, the resistors/capacitors/inductors may be replaced with remote actuated switching devices that are capable of altering the topology of the circuit (see FIG. 4). There are three modes of operation of the module. A) Power mode when the auxiliary module is in series with the main module to provide a higher voltage at the output; B) Energy mode when the auxiliary module is in parallel with the main module to provide rated current over a longer period of time at the output; C) Maintenance mode when the modules are in idle mode and balancing is in progress. In this mode the cells are in parallel based on positions in switch A/B. The Energy Management system (EMS) will provide the directive to operate in the selected mode (see FIG. 5). Cell balancing will continue until an even voltage has been achieved at the cell terminals. The energy management system might interrupt cell balancing if there is a need for discharge. The BMS controller receives directive from EMS and alters the switch positions to (re)create the topology. Unless interrupted, the battery will remain to be in maintenance mode until the cells are balanced. Apart from balancing, other protection mechanisms like that for fire, thermal and safety can operate concurrently in the controller.

FIG. 5 shows an exemplary process for operating the system of FIG. 4. Upon initialization, the battery units receive a mode selection from an energy management system.

In a power mode, the units are in series, and switch A is in position 1, switch B is in position 2, and balancing switches are open.

In an energy mode, the units are in parallel, and switch A is in position 1, switch B is in position 1, and balancing switches are open.

In a balancing mode, the units are idled for maintenance or other reasons, and switch A is in position 1, switch B is in position 2, and balancing switches are closed. According to the methods of the embodiments of the present invention, cell balancing may be efficiently performed according to the types and characteristics of battery cells by using the cell balancing apparatus and the energy storage system including the cell balancing apparatus.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a,” “an,” “the,” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention as defined by the appended claims and their equivalents.

What is claimed is:

1. A method to provide power from battery units, comprising:
placing units with a predetermined variance in voltages in a first configuration;
detecting a divergence in module voltages;
if the divergence crosses a threshold, creating a new configuration of units to provide an even voltage distribution; and
electrically rerouting the units to form the new configuration while the battery units are in an idle state or in a reduced mode of operation.

2. The method of claim 1, comprising providing inductors at both ends of the battery units.

3. The method of claim 1, comprising placing cells of the battery units in a series or a parallel configuration.

4. The method of claim 1, comprising using single pole double throw (SPDT) switches to reconfigure the battery units.

5. The method of claim 1, comprising taking the units off-line when changing the configuration.

6. The method of claim 1, comprising connecting the units using resistors.

7. The method of claim 6, comprising trickle charging a battery cell with the one or more resistors.

8. The method of claim 1, comprising managing heat dissipation of the one or more resistors.

9. The method of claim 1, comprising connecting the units using capacitors.

10. The method of claim 9, comprising balancing voltage differences across the capacitors.

11. The method of claim 9, wherein current flow in a branch circuit comprises:
$${i}_{k} = {C}_{k} \frac{{dv}_{k}}{dt}$$
where iₖ, Cₖ and vₖ are the current, capacitance and voltage of the k^{th} branch. In another embodiment an inductor can be added in series to capacitor to reduce the inrush current.

12. The method of claim 1, comprising generating current flow in a branch circuit with resistors or capacitors.

13. The method of claim 12, comprising providing inductive load in series with resistors or capacitors.

14. The method of claim 13, comprising providing a voltage drop across the inductor by
$${v}_{l , k} = - {L}_{k} \frac{{di}_{k}}{dt} = - {L}_{k} {C}_{k} \frac{{d}^{2} {v}_{C , k}}{{dt}^{2}}$$
where v_{l,k}, Lₖ and iₖ are the voltage drop across the inductor, inductance of inductor and current in k^{th} branch circuit.

15. The method of claim 1, comprising generating current flow in a branch circuit with resistors and capacitors.

16. The method of claim 15, comprising providing inductive load in series with resistors or capacitors.

17. The method of claim 1, comprising performing fast switching of SPDT switches to reduce cell balancing current by altering a rate of change of current and increasing voltage drop at an inductor and a capacitor.

18. The method of claim 1, wherein the units comprise battery cells.

19. The method of claim 1, wherein the units comprise battery modules.

20. The method of claim 1, wherein the units comprise battery packs.
